(19) United States
(12) Patent Application Publication
(10) Pub. No.: US 2024/0232283 A1
(43) Pub. Date: Jul. 11, 2024

(54) Flexible Grid Matrix for Comparable Event Outcomes of Opposing Statistics

(71) Applicant: Brian N. Miller, Cincinnati, OH (US)

(72) Inventor: Brian N. Miller, Cincinnati, OH (US)

(21) Appl. No.: 17/236,760

(22) Filed: Apr. 21, 2021

Related U.S. Application Data
(60) Provisional application No. 62/704,156, filed on Apr. 24, 2020.

(51) Int. Cl. G06F 17/16

(52) U.S. Cl. CPC G06F 17/16

(57) ABSTRACT

A selected comparative statistical result of an event is the deciding factor in the mechanics of the function. Result grid data of the event determine specific grid location and variable (symbol, value, character). As the stats change, so does the active square location on the grid. At the end of the event or select period, a grid location becomes the selected square and the variable (symbol, value, character) is determined as the result for that iteration or grid set. (each participant can have a different variable at that same square location). Back-end management process controls and creates weighted frequency of variables.

Used for sport organizations, competitive organizations, corporate programs, gaming events. A scalable program and digital platform for spectator events, philanthropic campaigns, corporate programs and gaming that can be administered as traditional printed items or in digital applications (mobile and otherwise).

### BACKGROUND

A unique, flexible grid program (process) that creates custom results based on statistical or other ordered outcome comparison of an event. (i.e., competitions in sport, promotions, units, scale, etc.—any two (2) statistical or other ordered data) This invention is an invention of the following type(s):
Method or Process
Grid matrix structure and manager program

### SUMMARY

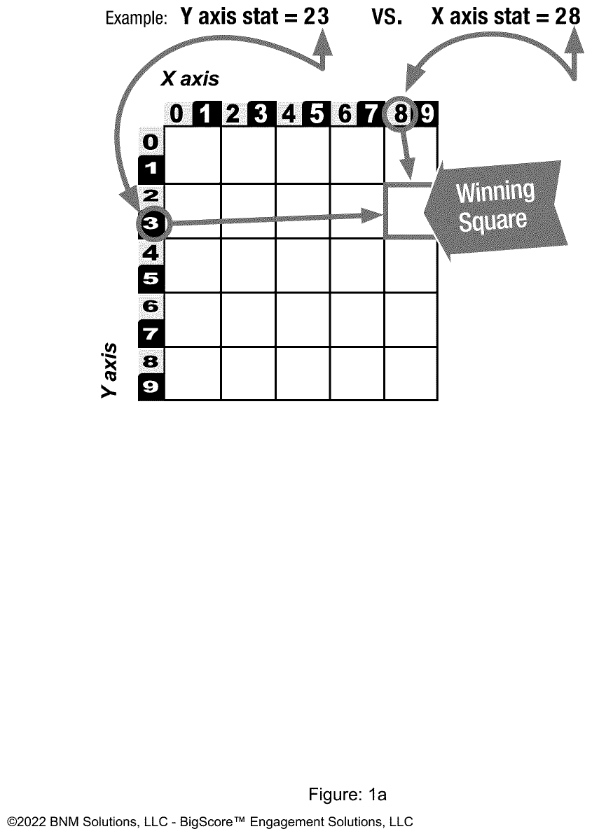

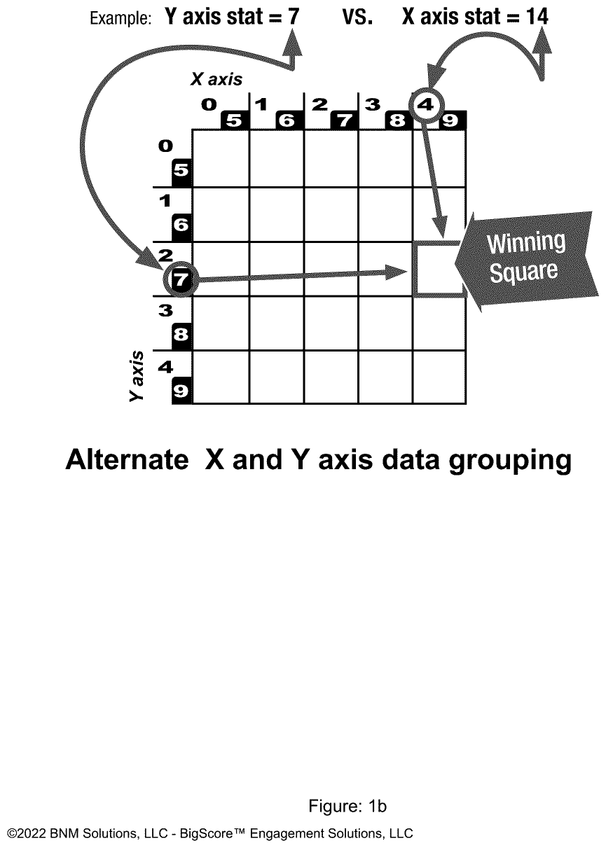

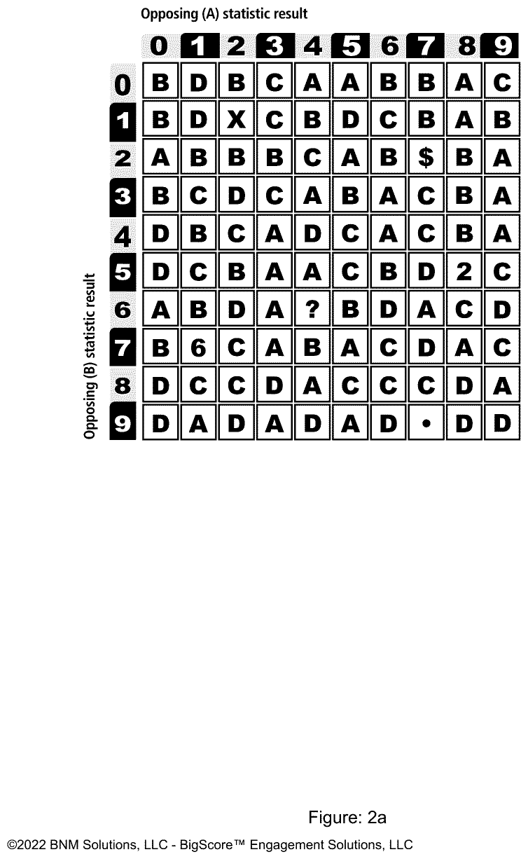

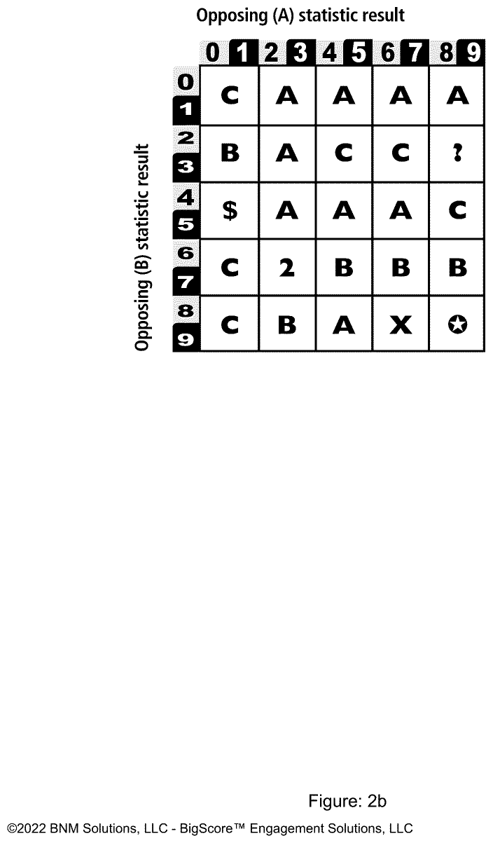

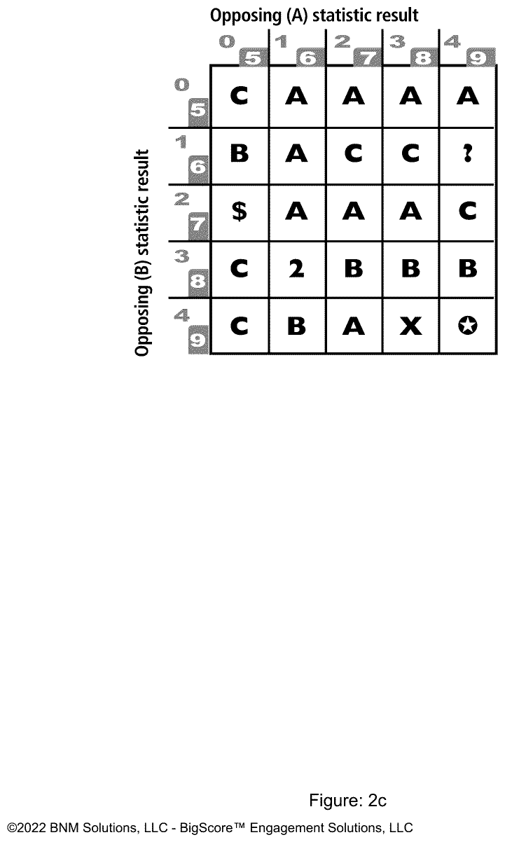

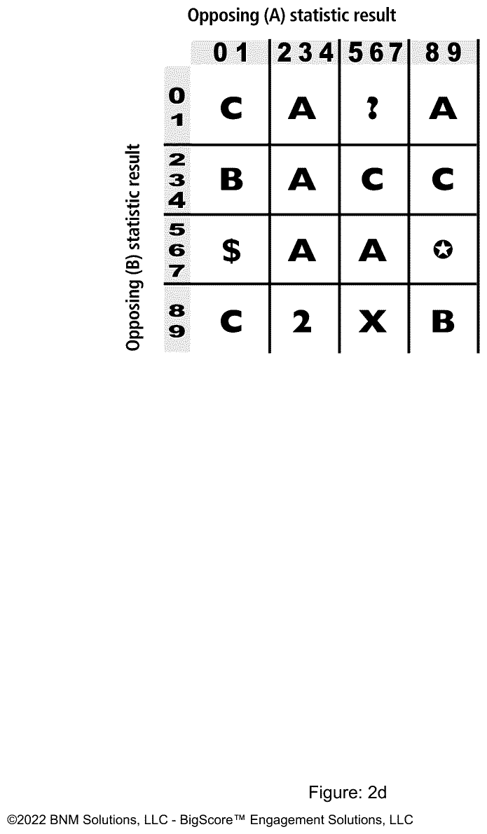

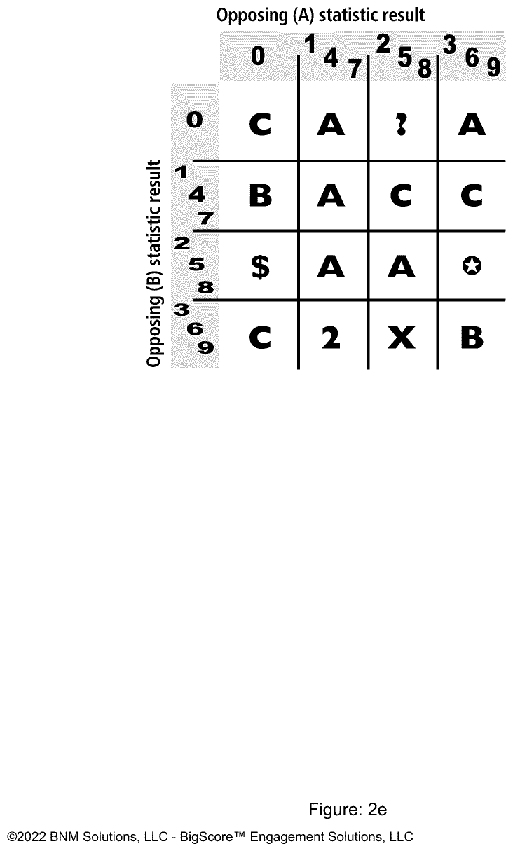

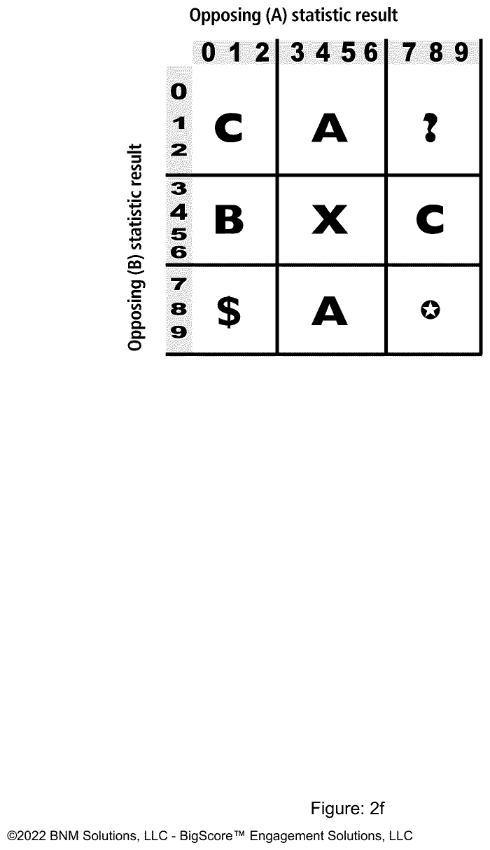

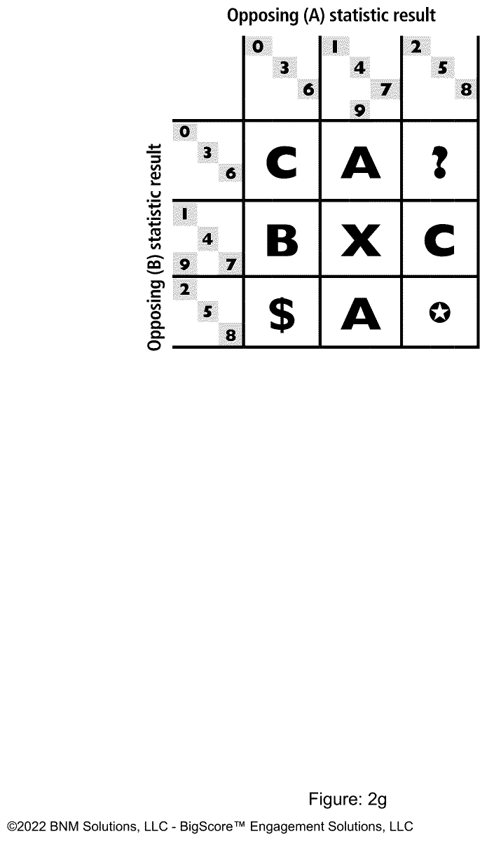

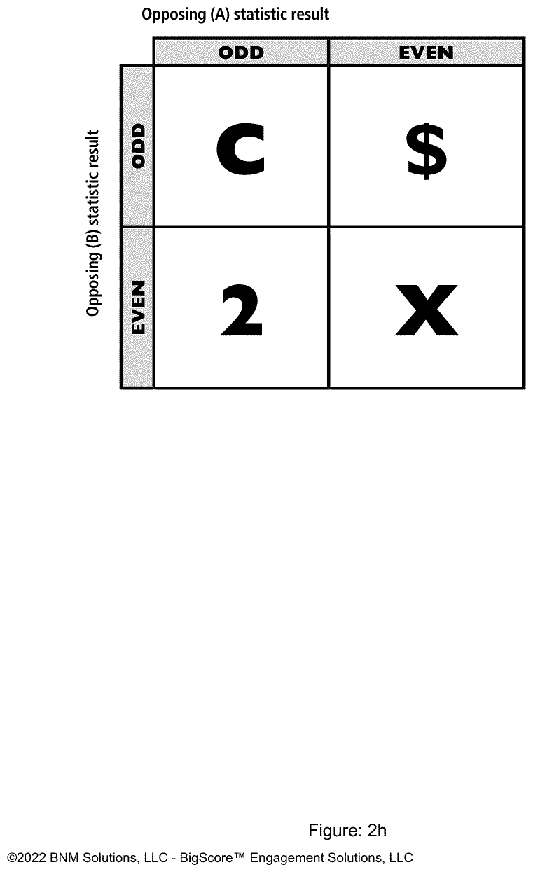

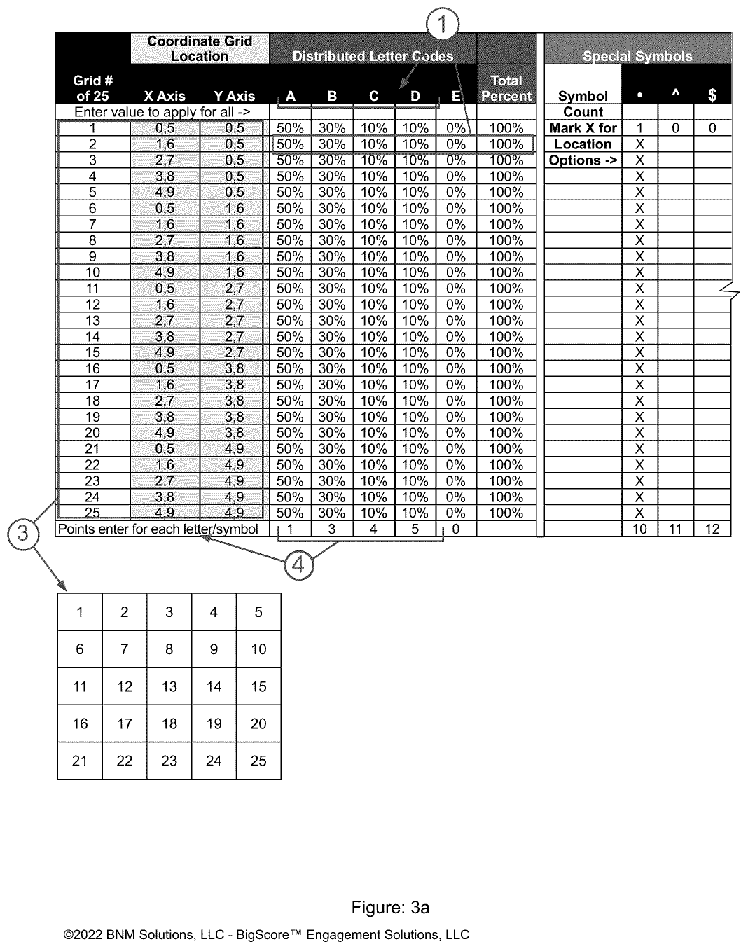

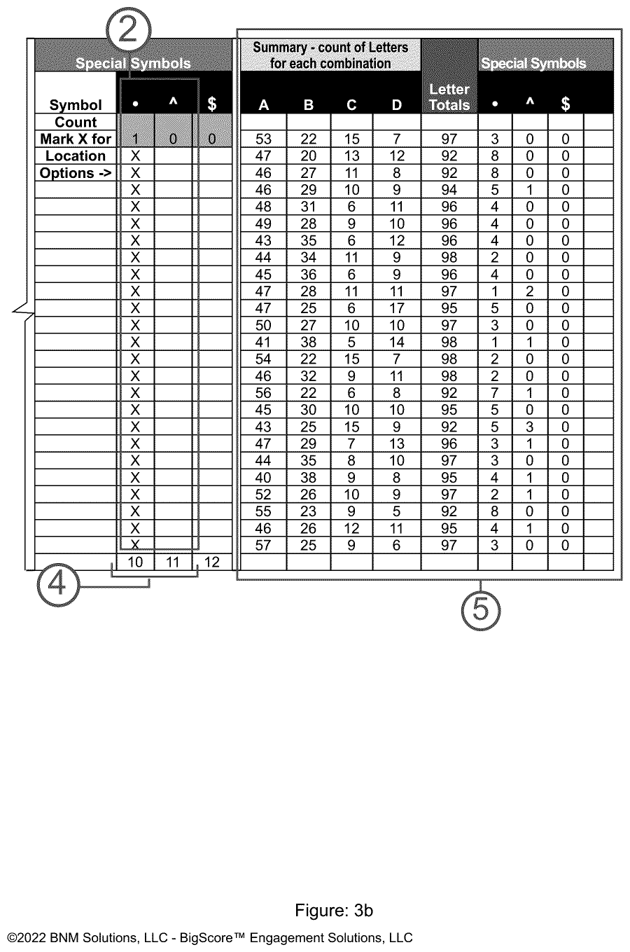

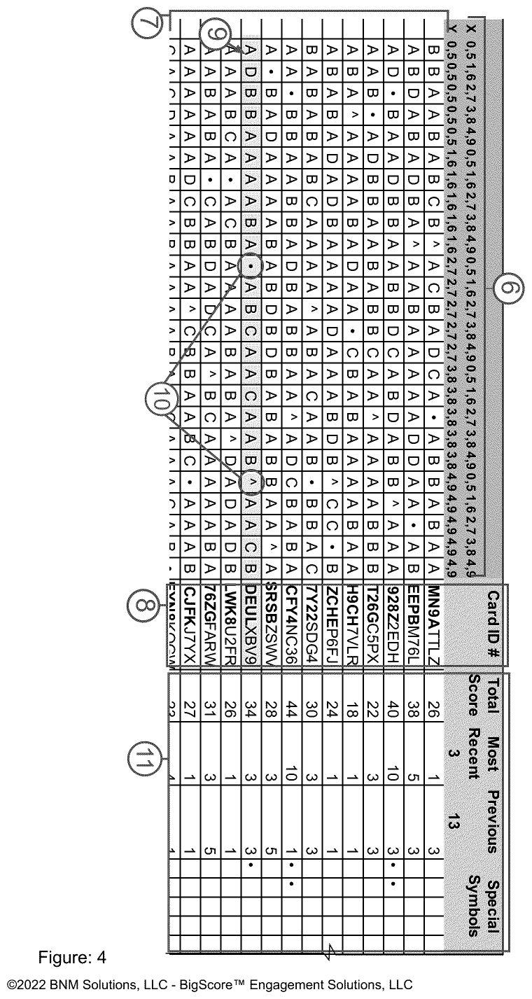

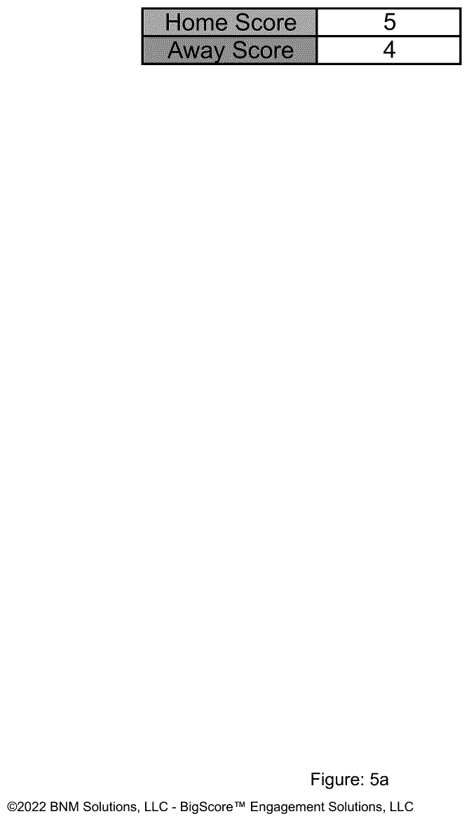

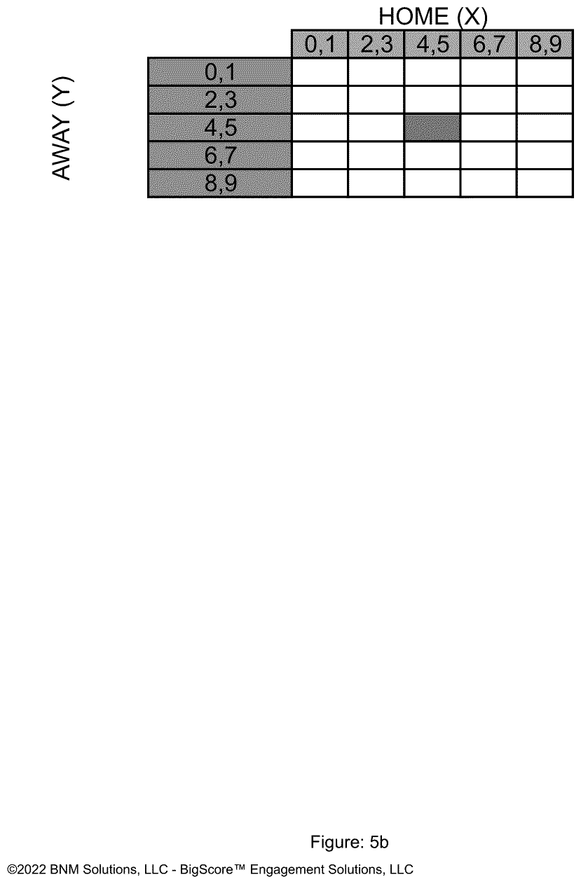

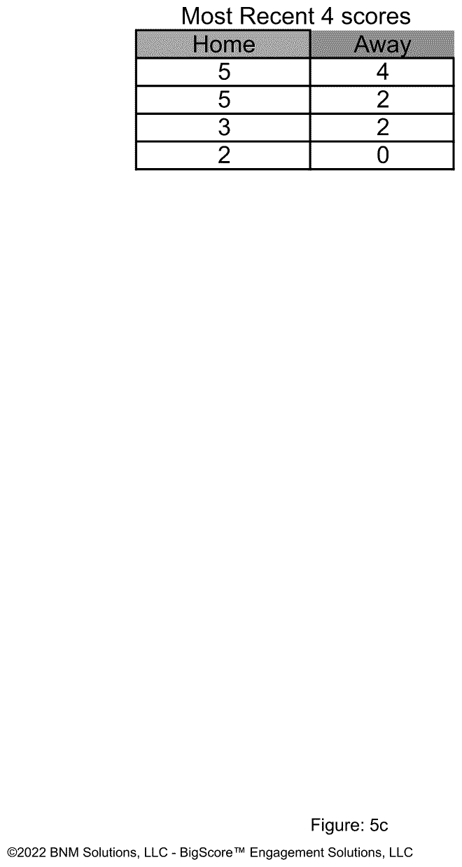

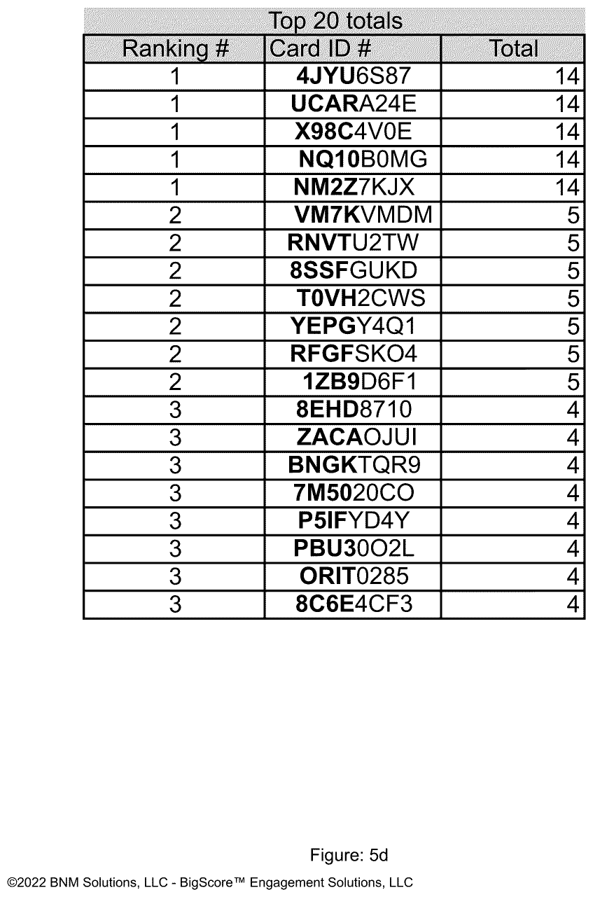

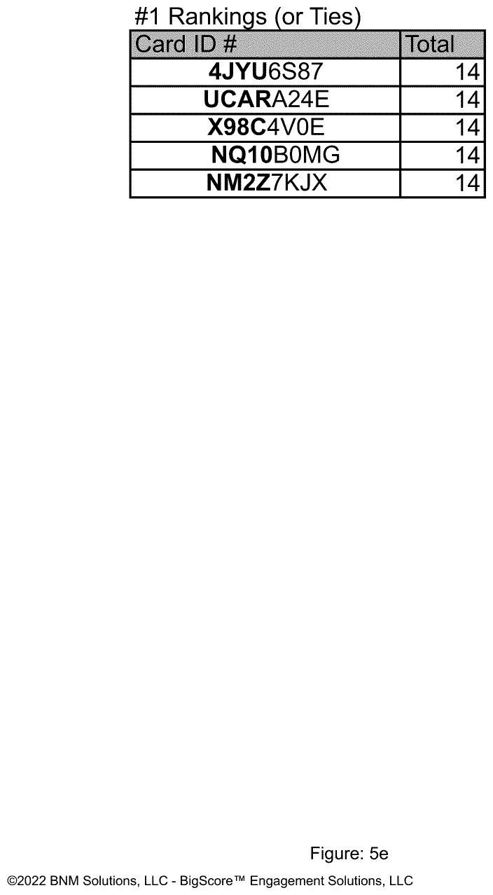

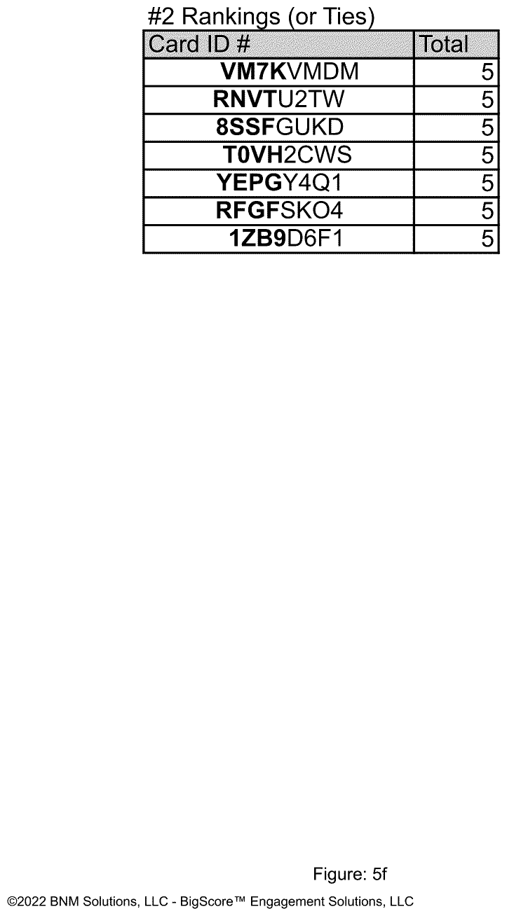

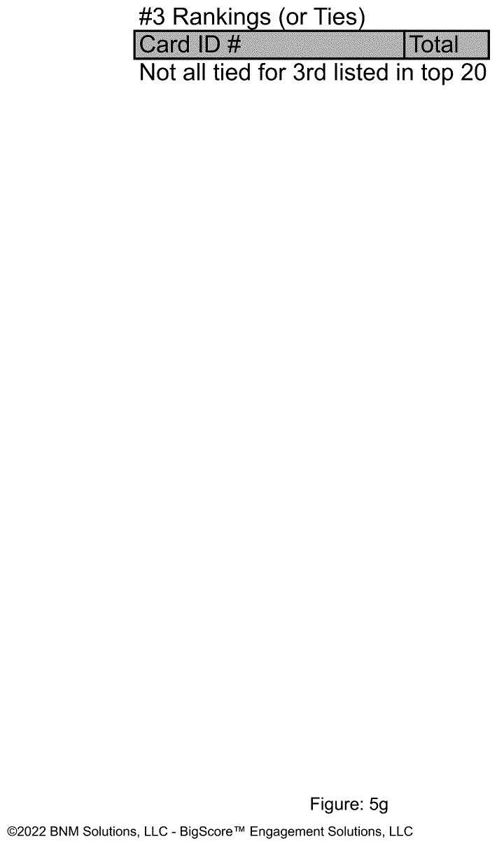

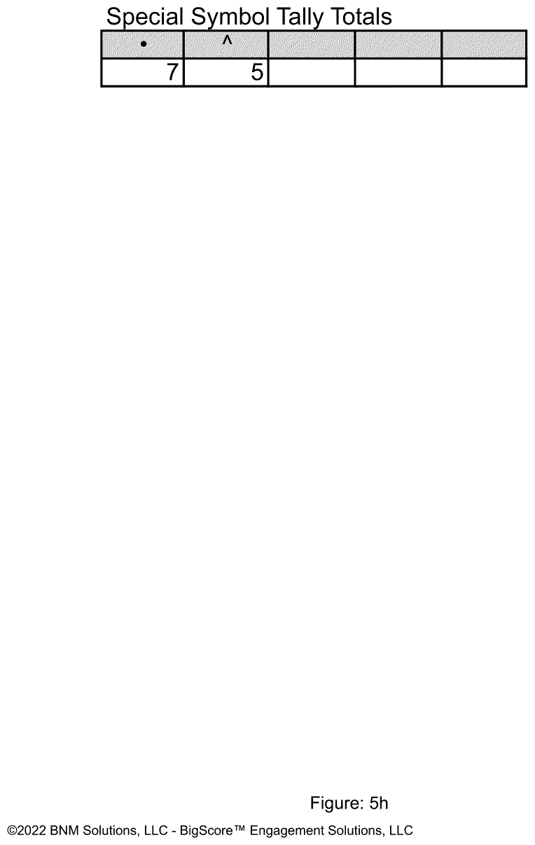

A grid program based on an X and Y axis matrix and last digit values or other hierarchical or ordered method (see FIGS. 1a and 1b) with a unique aspect in structure and use.
A selected comparative statistic results of an event, is the deciding factor in the mechanics of the function. Result grid data of the event determine specific grid location and represented variables (symbol, value, or character). (See FIG. 2a through 2h)
Each grid set or iteration can have a unique combination of variables to make the outcome different for each participant and result value options can be weighted to set the frequency of outcomes and offer select outcomes at each grid location (value, reward, or redeemable). A series of back-end algorithms generate variables to create custom grid iterations and can add a number of variables, edit, manage and decide frequency of variables used in each grid result. This back-end management tool can estimate and display total outcomes of each grid or iteration set to determine redemption volumes, budgets needed and total numbers per possible result and can tally optional points based on accumulated select values or points as the statistics change throughout the event (See FIGS. 3a and 3b, and FIG. 4)
Scalable, flexible and versatile data building formulas create versatile versions of grid layouts and iterations.
A ranking tally function can be incorporated and is based on prolific data changes (statistics or ordered data that change often, i.e., scoring)
   Point values are assigned to the variables, letter and/or symbols on the grid. As the event data changes, so does the grid position. With each change in grid position, a tally is added. Thus, prolific data changes cause a new sum to each user's point tally.
   A dashboard has been developed to show user point rankings. As the game progresses so do the point rankings. The user with the most “grid accumulated” points at the end of the event receives top rank or priority. (See FIG. 5a through 5h)

### BRIEF DESCRIPTION

FIG. 1a:
How the basic X and Y axis grid format relates to numeric stats

FIG. 1b:
Alternate number grouping on X and Y axis grid format

FIG. 2a:
X and Y axis example, 10×10 format

FIG. 2b:
X and Y axis example, 5×5 format

FIG. 2c:
X and Y axis example, 5×5 alternate format

FIG. 2d:
X and Y axis example, 4×4 format

FIG. 2e:
X and Y axis example, 4×4 alternate format

FIG. 2f:
X and Y axis example, 3×3 format

FIG. 2g:
X and Y axis example, 3×3 alternate format

FIG. 2h:
X and Y axis example, 2×2 alternate format

FIG. 3a:
Back-end management tool and iteration generator of variables. Left half of table

FIG. 3b:
Back-end management tool and iteration generator of variables. Right half of table

FIG. 4:
Iteration results list of variables

FIG. 5a:
Dashboard, comparative statistic “home” and “Away” (X and Y axis)

FIG. 5b:
Dashboard, indicating present grid location of X and Y comparative statistic

FIG. 5c:
Dashboard, most recent four comparative statistics

FIG. 5d:
Dashboard, top 20 tally point leaders

FIG. 5e:
Dashboard, point leaders tied at #1 ranking

FIG. 5f:
Dashboard, point leaders tied at #2 ranking

FIG. 5g:
Dashboard, point leaders tied at #3 ranking

FIG. 5h:
Dashboard, special symbols tally totals

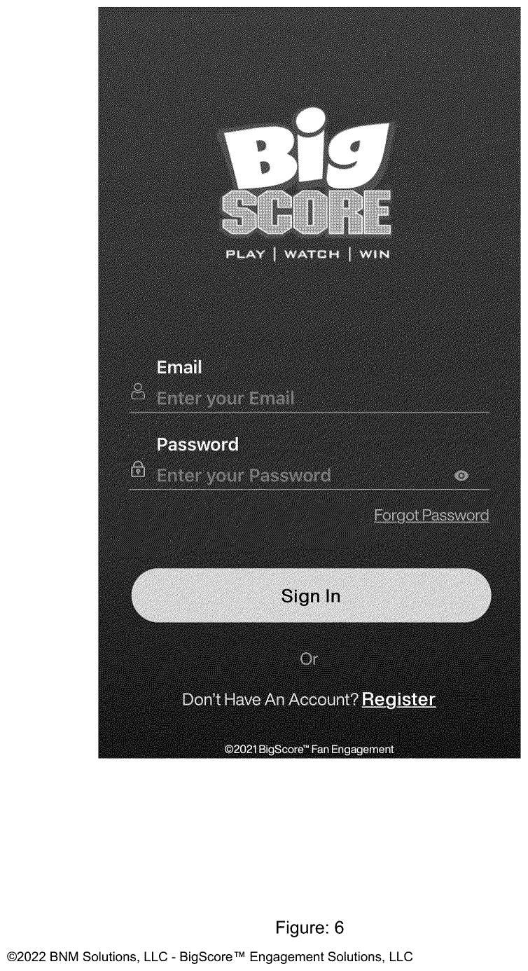

FIG. 6:
Sample login screen and link to registration

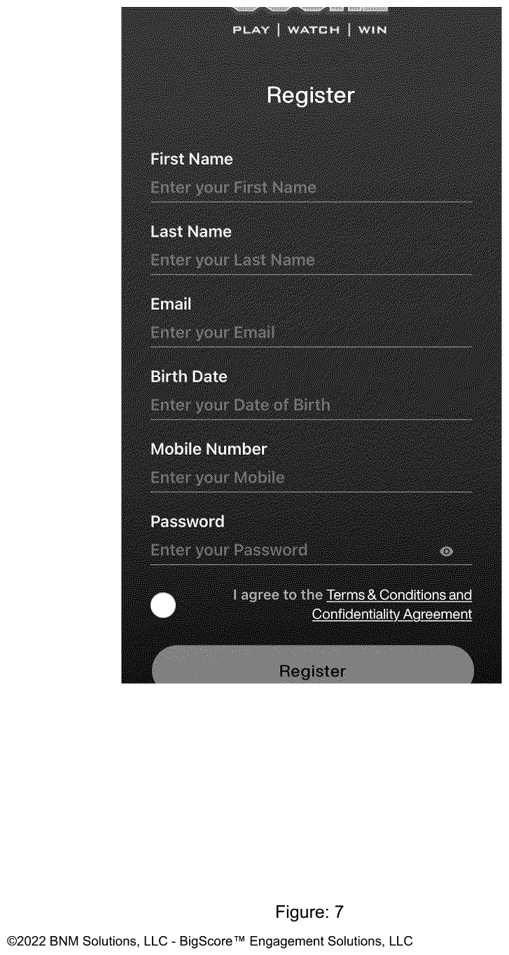

FIG. 7:
Sample registration for first time users and terms and conditions link

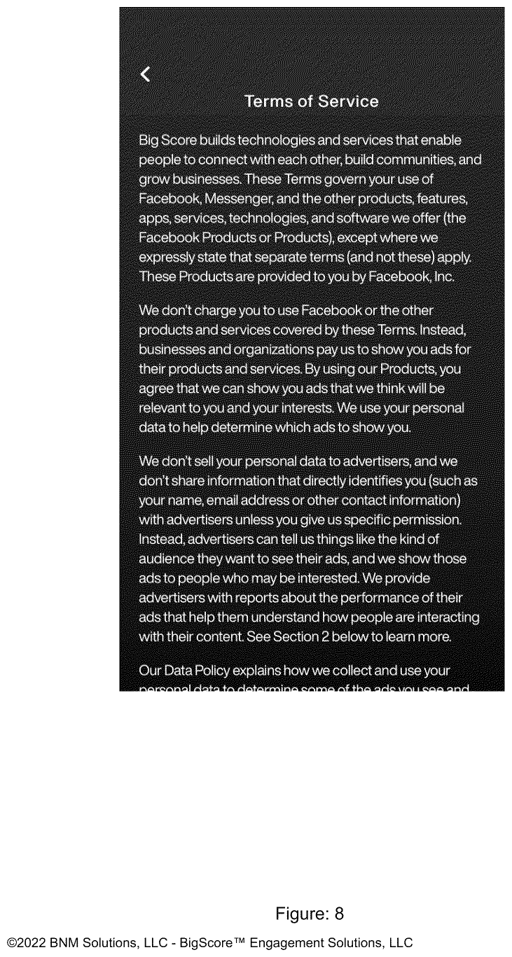

FIG. 8:
Sample terms and conditions screen

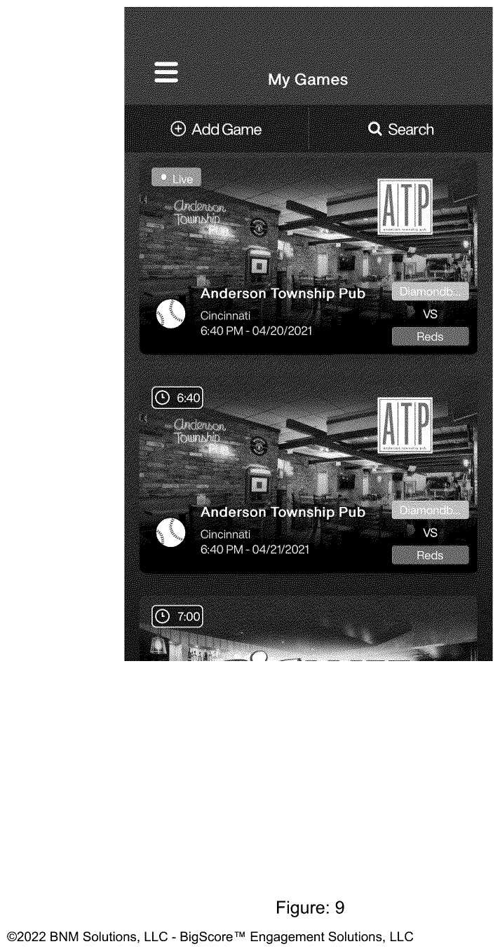

FIG. 9:
Sample My Games screen where selected event games are shown

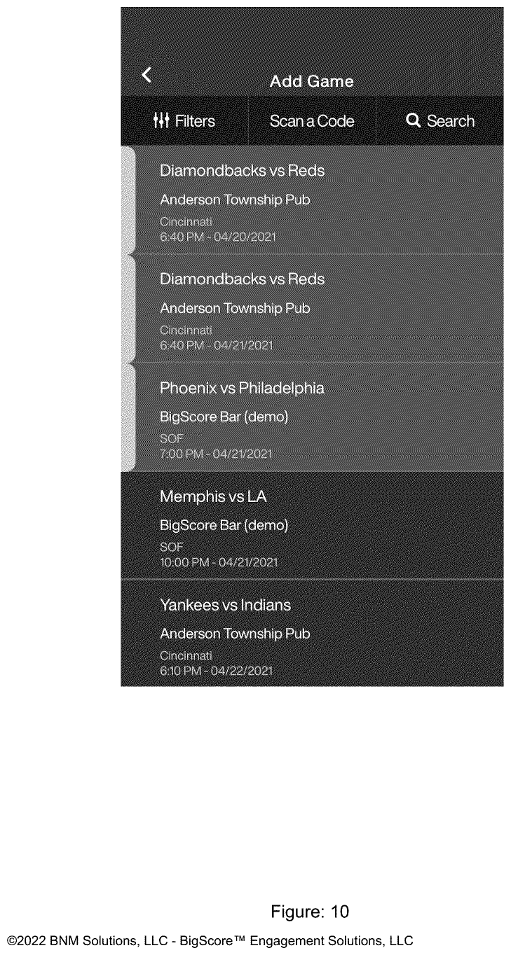

FIG. 10:
Sample Add Game screen

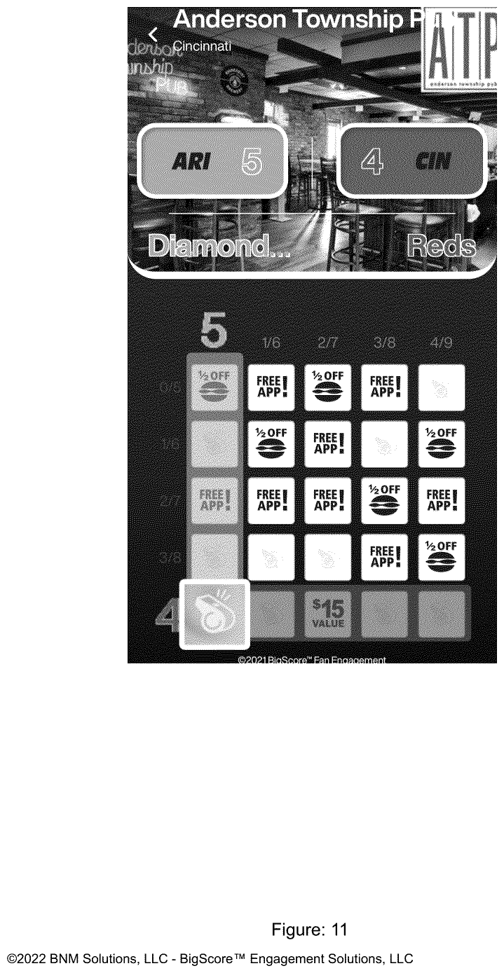

FIG. 11:
Sample active game grid showing live event happening

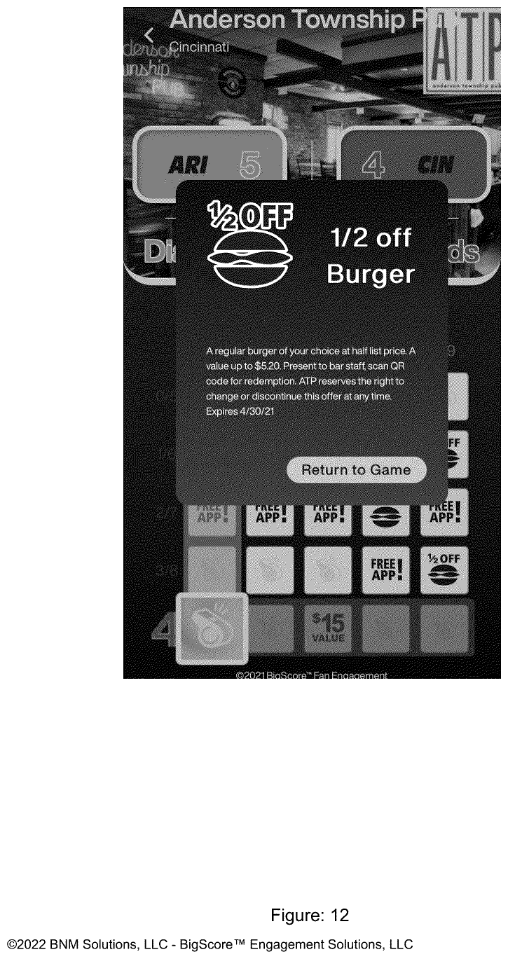

FIG. 12:
Sample popup screen displaying a select prize offer

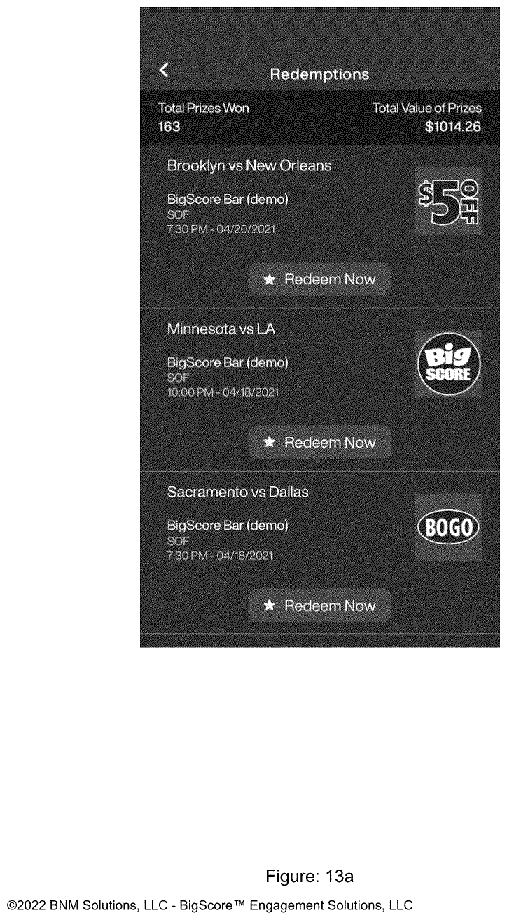

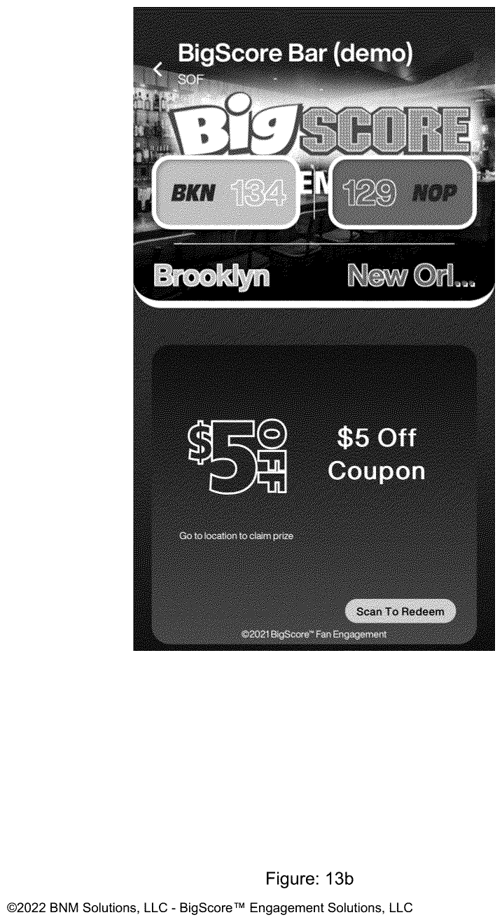

FIG. 13a:
Sample Redemptions list screen

FIG. 13b:
Sample Redemption screen

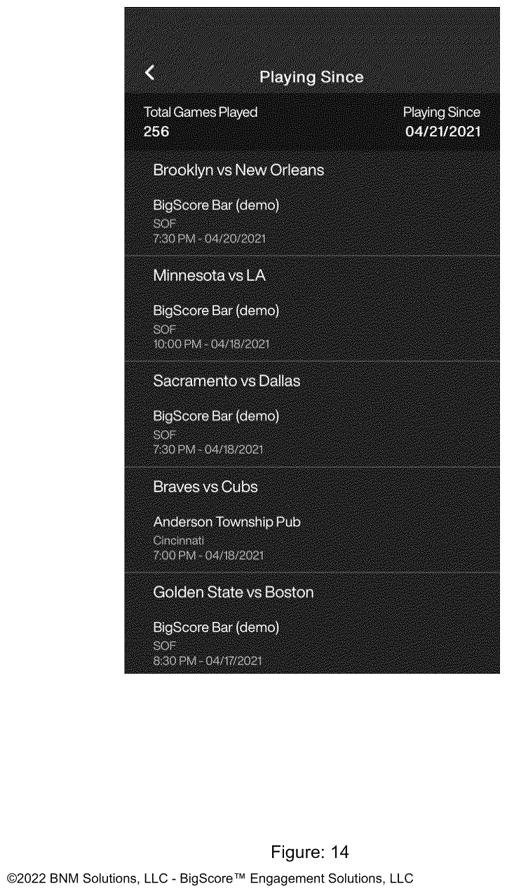

FIG. 14:
Sample (Playing Since) History of played events listing

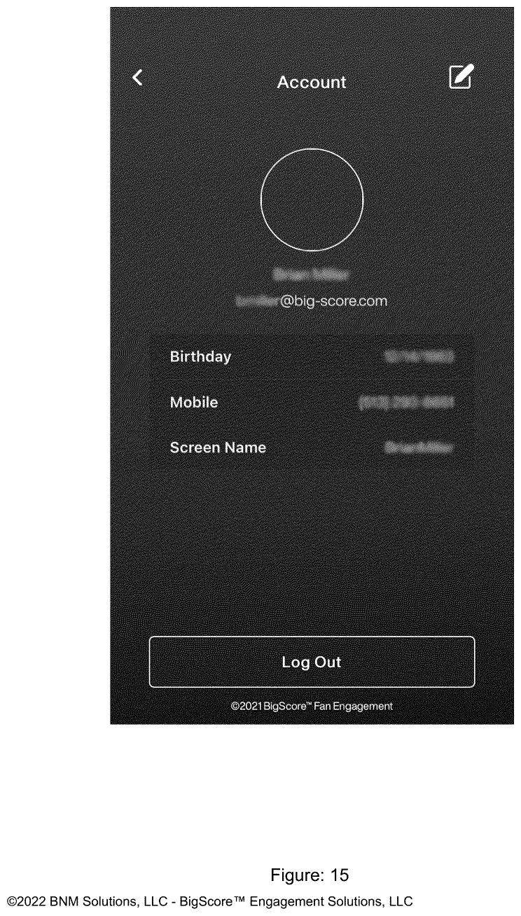

FIG. 15:
Sample user account information and logout function

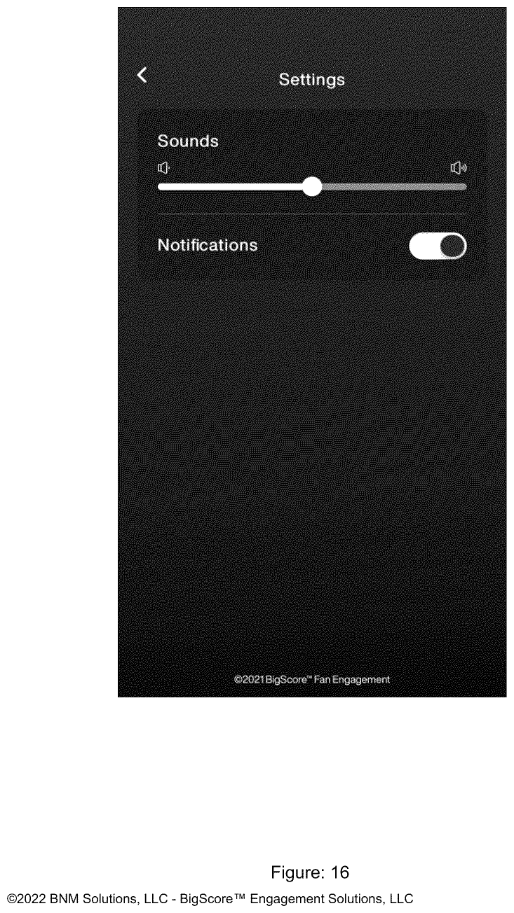

FIG. 16:
Sample Settings screen

### DETAIL DESCRIPTIONS

### FIG. 1a:

### How the Basic X and Y Axis Grid Format Relates to Numeric Stats.

A grid program based on an X and Y axis matrix and use last digit numeric values (in this example) or other hierarchical linear or ordered method with a unique aspect in structure can be used. A selected comparative statistical result of a comparative event is the deciding factor in the mechanics of the function. Results are indicated in the grid and the event determines specific grid location.

### FIG. 1b:

### How the Basic X and Y Axis Grid Format Relates to Numeric Stats.

A grid program based on an X and Y axis matrix and use last digit numeric values (in this example) an alternate hierarchical or ordered method with a unique aspect in structure can be used. A selected comparative statistical result of a comparative event is the deciding factor in the mechanics of the function. Results are indicated in the grid and the event determines specific grid location.

### FIG. 2a:

### X and Y Axis Example, 10×10 Format.

A selected comparative statistical result of a comparative event is the deciding factor in the mechanics of the function. Result grid data of the event determine specific grid location and represent variable (symbol, value, character). X and Y axis example use numeric values 0 to 9, 10×10 grid.

### FIG. 2b:

### X and Y Axis Examples, 5×5, Linear Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 5×5 grid.

### FIG. 2c:

### X and Y Axis Examples, 5×5, Alternate Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 5×5 grid.

### FIG. 2d:

### X and Y Axis Examples, 4×4, Linear Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 4×4 grid.

### FIG. 2e:

### X and Y Axis Examples, 4×4, Alternate Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 4×4 grid.

### FIG. 2f:

### X and Y Axis Examples, 3×3, Linear Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 3×3 grid.

### FIG. 2g:

### X and Y Axis Examples, 3×3, Alternate Numbering Format.

A selected comparative statistical result of a comparative event is the deciding factor in the mechanics of the function. Result grid data of the event determine specific grid location and represent variable (symbol, value, character). X and Y axis example use numeric values 0 to 9, 3×3 grid.

### FIG. 2h:

### X and Y Axis Examples, 2×2, Odd/Even Format.

A selected comparative statistical result of a comparative event is the deciding factor in the mechanics of the function. Result grid data of the event determine specific grid location and represent variable (symbol, value, character). X and Y axis example as odd and even, 2×2 grid.

### FIG. 3a:

### Back-End Management Tool and Iteration Generator of Variables.

The management tool: Each grid set or iteration can have a unique combination of variables to make the outcome different for each participant and result value options can be weighted to set the frequency of outcomes and offer select outcomes at each grid location (value, reward, redeemable). A series of back-end algorithms generate variables to create custom grid iterations and can add a number of variables, edit, and manage.
1) Variables generated on each grid location throughout the total iteration (grid set). Percentages for each variable can be controlled. Sum of percentages must =100% (or total iterations generated) 3) Each location on the grid is designated (1-25) on this 5×5 grid example. X and Y coordinates are indicated and, in this case, numeral values 0 to 9 for both X and Y axis. Note that each coordinate location share two values in a 5×5 format.
4) Tally values can be associated with each variable or symbol to allow a ranking option to the iterations generated. Results are shown on the dashboard in FIG. 4.

### FIG. 3b:

### Back-End Management Tool and Iteration Generator of Variables.

The management tool: Each grid set or iteration can have a unique combination of variables to make the outcome different for each participant and result value options can be weighted to set the frequency of outcomes and offer select outcomes at each grid location (value, reward, redeemable). A series of back-end algorithms generate variables to create custom grid iterations and can add a number of variables, edit, and manage.
2) Special symbols can be added to the iterations. Number of each symbol per grid and selected grid locations can be controlled.
4) Tally values can be associated with each variable or symbol to allow a ranking option to the iterations generated. Results are shown on the dashboard in FIG. 4.
5) Totals of variables and symbols results of the collective iterations is displayed

### FIG. 4:

### Iteration Results List of Variables.

The Iterations (50 grid result sets shown) are generated based on selections made in the back-end management tool shown in FIGS. 3a and 3b. This also shows ranking value options, if used.

Each iteration shown is a unique grid set.
6) Grid location (coordinates) as referenced in FIG. 3a
7) List of generated iterations (grid sets). 50 iterations listed in this generation
8) Each iteration is given a generated ID code
9) Indicates on iteration set and ID. A set of 25 grid locations with generated variables as referenced in FIG. 3a.
10) Indicates special symbols referenced in FIGS. 3a and 3b.
11) Indicates tally numbers (scores noted in this sample) and special symbols tally if progressive totals are used

### FIG. 5a:

Dashboard with Results Indicates Present Comparative Data Input (a Home Vs Away Score in this Sample) of Each Change in Grid Position, a Tally is Added.

The dashboard in general: Point values are assigned to the value variable, letter and/or symbols on the grid. As the event data changes, so does the grid position. Each change in grid position, a tally is added. Thus, prolific data changes cause new sum to each user's point tally. A dashboard has been developed to show user point rankings. As the game progresses, so do the point rankings.

### FIG. 5b:

Dashboard with results indicator to show present grid location of the score

### FIG. 5c:

Dashboard with results displays the 4 most recent scores

### FIG. 5d:

Dashboard with results indicates the ranking tally for the top 20 iterations, with ID number and tally total.

(Notice that ranking ties are possible)

### FIG. 5e:

Dashboard with results of first (1st) place. If ties exist of more that 20 . . . ranking list is not displayed in this dashboard, but tally is recorded on results referenced on FIG. 4.

### FIG. 5f:

Dashboard with results of first (2nd) place. If ties exist of more that 20 . . . ranking list is not displayed in this dashboard, but tally is recorded on results referenced on FIG. 4.

### FIG. 5g:

Dashboard with results of first (3rd) place. If ties exist of more that 20 . . . ranking list is not displayed in this dashboard, but tally is recorded on results referenced on FIG. 4.

### FIG. 5h:

Dashboard with results Indicates tally numbers of special symbols.

### FIG. 6:

Sample login screen and link to registration on digital application

### FIG. 7:

Sample registration for first time users and terms and conditions link on digital application

### FIG. 8:

Sample terms and conditions screen on digital application

### FIG. 9:

Sample My Games screen where selected event games are shown on digital application

### FIG. 10:

Sample Add Game screen where user selects events to add to My Games to actively play along on digital application

### FIG. 11:

Sample active game grid showing live event happening (showing scores in x and y axis grid) on digital application

### FIG. 12:

Sample popup screen displaying a select prize offer on digital application

### FIG. 13a:

Sample Redemptions screen where users winning results are listed showing redeemed and non-redeemed items.

### FIG. 13b:

Sample Redemptions Detail screen. Specific prize offer details and “scan to redeem” link for digital redemption validation on digital application.

### FIG. 14:

Sample (Playing Since) History of played events listing on digital application.

### FIG. 15:

Sample user account information and logout function on digital application

### FIG. 16:

Sample Settings screen for user experience adjustment on digital application

1. (canceled)

2. (canceled)

3. (canceled)

4. (canceled)

5. (canceled)

6. (canceled)

7. A selected comparative statistical result of an event is the deciding factor in the mechanics of the function; result grid data of the event determine specific grid location and represent variable (symbol, value, character).

8. The system of claim 7 further comprising each grid set or iteration can have a unique combination of variables to make the outcome different for each participant and result value options can be weighted to set the frequency of outcomes and offer select outcomes at each grid location (value, reward, redeemable); a series of back-end algorithms generate variables to create custom grid iterations and can add a number of variables, edit, manage and decide frequency of variables used in each grid result; this back-end management tool can estimate and display total outcomes of each grid or iteration set to determine redemption volumes, budgets needed and total numbers per possible result.

9. Scalable, flexible and versatile data building formulas create versatile versions of grid layouts and iterations.

10. A ranking tally function can be incorporated and is based on prolific data changes (statistics or ordered data that change often, i.e., scoring)

11. The ranking tally of claim 10 further comprising point values can be assigned to the value variable, letter and/or symbols on the grid. As the event data changes, so does the grid position; with each change in grid position, a tally is added; prolific data changes cause new sum to each user's point tally.

12. The point values of claim 11 further comprising of a dashboard has been developed to show user point rankings; as the game progresses, so do the point rankings; the user with the most “grid accumulated” points at the end of the event receives top rank or priority.
